(19) United States
(12) Patent Application Publication
(10) Pub. No.: US 2024/0169756 A1
(43) Pub. Date: May 23, 2024

(54) FINGERPRINT SENSOR PACKAGE AND SMART CARD INCLUDING THE SAME

(71) Applicant: SAMSUNG ELECTRONICS CO., LTD., Suwon-si (KR)

(72) Inventors: JAEHYUN LIM, Suwon-si (KR); Inho Choi, Suwon-si (KR); Hyunjong Moon, Suwon-si (KR); Kwangjin Lee, Suwon-si (KR)

(73) Assignee: SAMSUNG ELECTRONICS CO., LTD., Suwon-si (KR)

(21) Appl. No.: 18/223,853

(22) Filed: Jul. 19, 2023

(30) Foreign Application Priority Data
Nov. 18, 2022 (KR) 10-2022-0155522

(51) Int. Cl. G06V 40/13

(52) U.S. Cl. CPC G06V 40/1306

(57) ABSTRACT

A fingerprint sensor package, including a package substrate which includes a cavity; a sensing substrate on the package substrate, the sensing substrate comprising a first surface and a second surface opposite to each other; a controller chip on the first surface of the sensing substrate; and a molding layer on the controller chip and the first surface of the sensing substrate, wherein the second surface of the sensing substrate is exposed by the cavity

### CROSS-REFERENCE TO RELATED APPLICATION

The application is based on and claims priority under 35 U.S.C § 119 to Korean Patent Application No. 10-2022-0155522 filed on Nov. 18, 2022 in the Korean Intellectual Property Office, the disclosure of which is incorporated by reference herein in its entirety.

### BACKGROUND

### 1. Field

The disclosure relates to a fingerprint sensor package and a smart card including the same.

### 2. Description of Related Art

Fingerprint recognition technology may be used to prevent various security incidents by recognizing a fingerprint of a user to undergo registration and authentication procedures. In particular, this may be applied to network defense of individuals and organizations, protection of various contents and data, and secure access to financial information. The fingerprint sensor may acquire a fingerprint information of a user using at least one of an optical method, a capacitive method, an ultrasonic method, and a thermal sensing method. It may be desirable to achieve low cost while reducing the size and thickness of the product. Accordingly, there is a need for a fingerprint sensor package which satisfies economic feasibility while maintaining the reliability and sensitivity of the acquisition of fingerprint information and reducing the total size and height.

### SUMMARY

Provided are a fingerprint sensor package with improved reliability and a smart card including the same.

Additional aspects will be set forth in part in the description which follows and, in part, will be apparent from the description, or may be learned by practice of the presented embodiments.

In accordance with an aspect of the disclosure, a fingerprint sensor package includes a package substrate including a cavity; a sensing substrate on the package substrate, the sensing substrate comprising a first surface and a second surface which are opposite to each other; a controller chip on the first surface of the sensing substrate; and a molding layer on the controller chip and the first surface of the sensing substrate, wherein the second surface of the sensing substrate is exposed by the cavity.

In accordance with an aspect of the disclosure, a fingerprint sensor package includes a core dielectric layer having a first surface and a second surface opposite to each other, the core dielectric layer comprising a cavity which penetrates from the first surface toward the second surface; a sensing substrate on the first surface of the core dielectric layer; a ground bezel on the second surface of the core dielectric layer; an adhesion layer between the core dielectric layer and the sensing substrate; a controller chip on the sensing substrate; and a molding layer on the controller chip, the sensing substrate, and the first surface of the core dielectric layer, wherein the cavity vertically overlaps the sensing substrate.

In accordance with an aspect of the disclosure, a smart card includes a main body comprising a groove region and a connection pad; a security chip in the main body; and a fingerprint sensor package configured to sense a fingerprint and to transmit a sensing result to the security chip, wherein the fingerprint sensor package includes: a package substrate which comprises a core dielectric layer comprising a cavity, a first bonding pad on a top surface of the core dielectric layer, and an external connection pad on an edge of the top surface; a sensing substrate on the top surface, wherein the sensing substrate comprises a sensing region on which sensing patterns are provided and a peripheral region on which a second bonding pad is provided, the peripheral region surrounding the sensing region; a conductive wire extending between the first bonding pad and the second bonding pad, and connecting the first bonding pad to the second bonding pad; a controller chip on the sensing substrate; and a molding layer on the sensing substrate and the top surface, wherein the molding layer is disposed on the sensing substrate and the first bonding pad and exposes the external connection pad, wherein the external connection pad of the package substrate is coupled to the connection pad of the main body, wherein the cavity has a first width in a first direction, wherein the sensing substrate has a second width in the first direction, and wherein the second width is greater than the first width.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a simplified perspective view showing a smart card according to an embodiment.

FIG. 2 illustrates a simplified bottom view showing a layout of some components of a fingerprint sensor package according to an embodiment.

FIG. 3 illustrates a cross-sectional view taken along line I-I′ of FIG. 2 according to an embodiment.

FIG. 4 illustrates a cross-sectional view taken along line II-IF of FIG. 2 according to an embodiment.

FIG. 5 illustrates an enlarged view showing section AA of FIG. 2 according to an embodiment.

FIG. 6 illustrates a simplified plan view showing a fingerprint sensor package according to an embodiment.

FIG. 7 illustrates an enlarged view showing section BB of FIG. 6 according to an embodiment.

FIG. 8 illustrates a cross-sectional view showing a fingerprint sensor package according to an embodiment.

FIG. 9 illustrates a cross-sectional view showing a fingerprint sensor package according to an embodiment.

FIGS. 10A to 10F illustrate cross-sectional views showing a method of fabricating a smart card according to an embodiment.

### DETAILED DESCRIPTION

The following will now describe some embodiments in conjunction with the accompanying drawings.

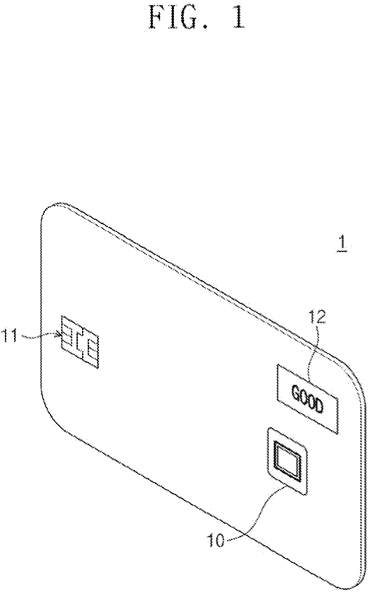

FIG. 1 illustrates a simplified perspective view showing a smart card 1 according to some embodiments.

Referring to FIG. 1, the smart card 1 may include a fingerprint sensor package 10, a security chip 11, and a display unit 12. The smart card 1 may further include a memory device for storing information which may be displayed on a credit card or check card, such as a card number, an expiration date, and a name of a user. The smart card 1 may further include a radio-frequency (RF) chip. The fingerprint sensor package 10 may recognize a touched fingerprint when the user brings a fingerprint of the user into contact with a fingerprint sensor. The fingerprint sensor package 10 may compare recognized fingerprints with registered fingerprints to determine whether the recognized fingerprints match the registered fingerprints. The fingerprint sensor package 10 may operate after the smart card 1 is switched to an on state. The security chip 11 may store encrypted financial information. When the recognized fingerprint matches the registered fingerprint, the security chip 11 may grant payment authorization to the user of the smart card 1. For example, based on recognition results of the fingerprint sensor package 10, the smart card 1 may grant a payment right to the user to thereby prevent financial accidents caused by theft or loss. The display unit 12 may display whether the recognized fingerprint matches the registered fingerprint, whether the smart card 1 is in an on state or an off state, and the like. The display unit 12 may display letters, numbers, special symbols, and the like, and in some cases, may further include a light emitting unit. In embodiments, the display unit 12 may be omitted depending on a type of the smart card 1. When the smart card 1 contacts an RF reader, power may be applied using a wireless charging or power supply process, to allow the smart card 1 to authenticate fingerprints. Accordingly, it may be possible to achieve high security against leakage of information such as a personal identification number (PIN) or the like.

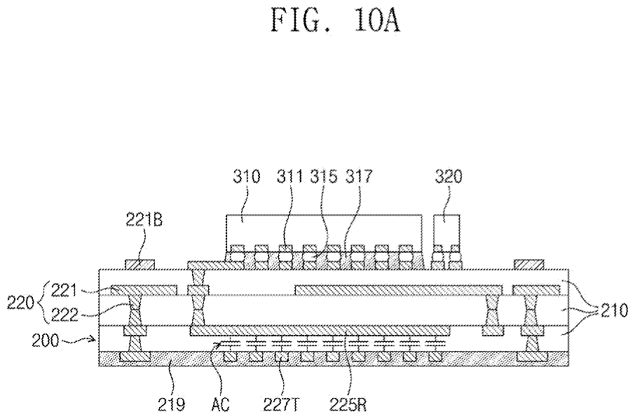

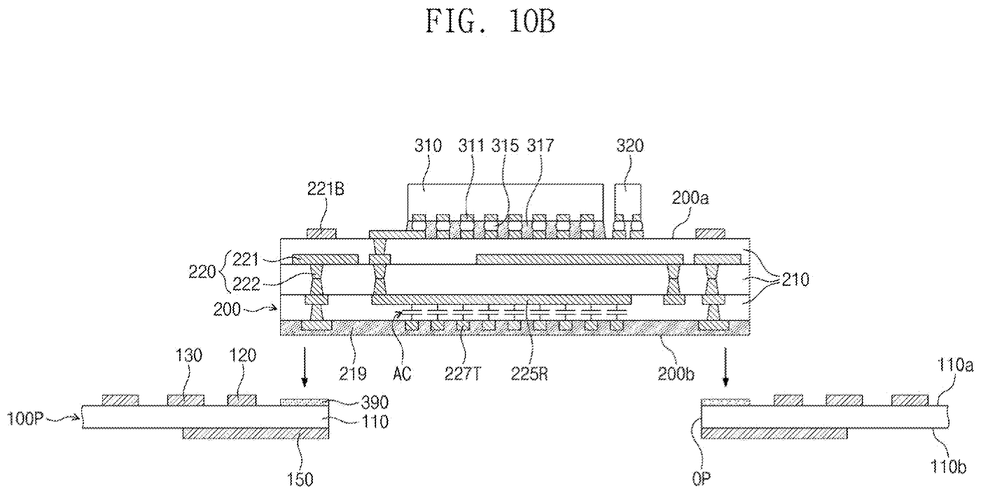

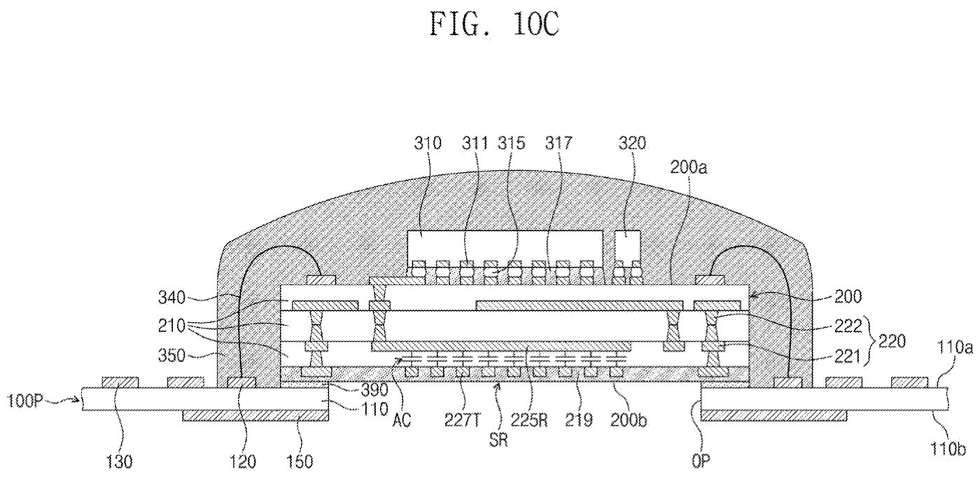

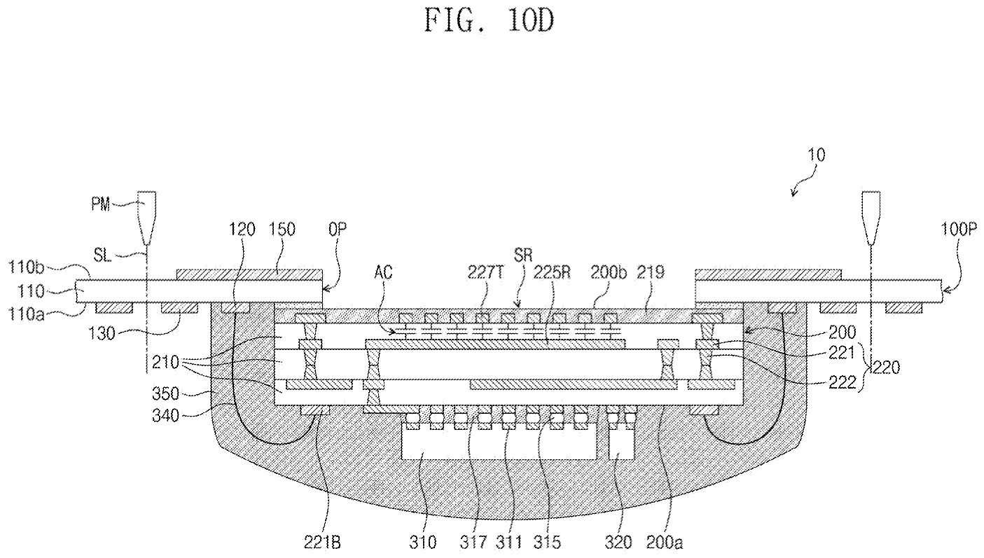

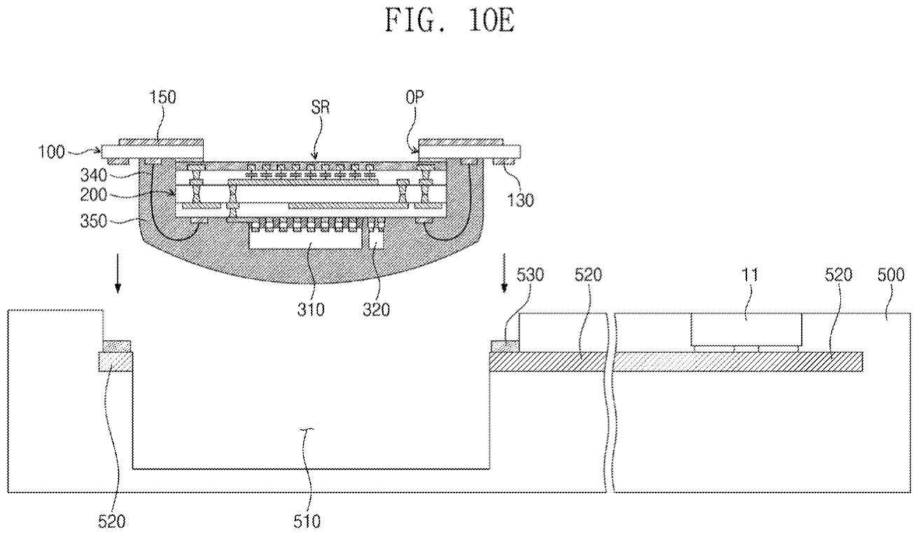

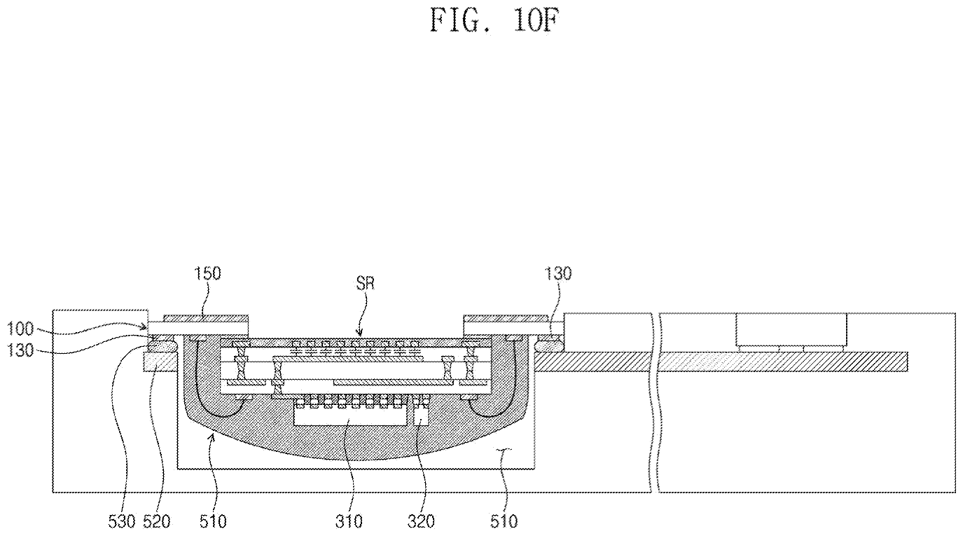

Because the smart card 1 according to embodiments includes the fingerprint sensor package 10 and has a thickness that is same or similar to a thickness of a credit card or check card which is not a smart card, for example a credit card or check card which does not include the fingerprint sensor package 10, the smart card 1 may provide a high level of user experience. In addition, a cross-section of the smart card 1 according to embodiments may be substantially the same as or similar to that schematically shown for example in FIG. 10F.

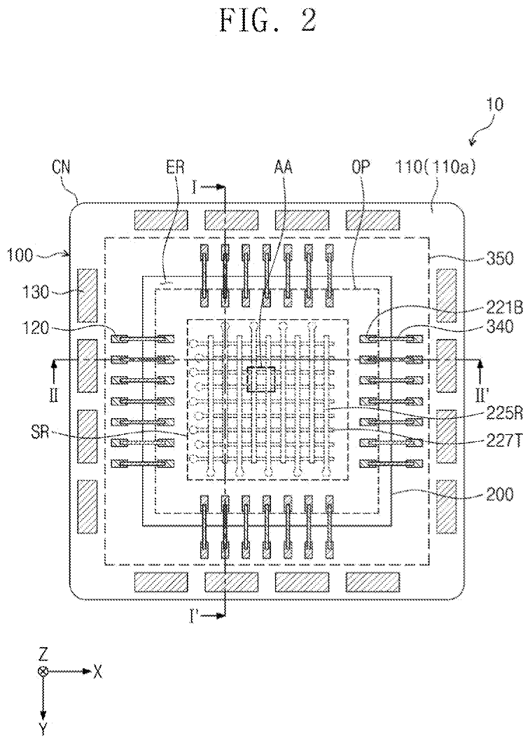

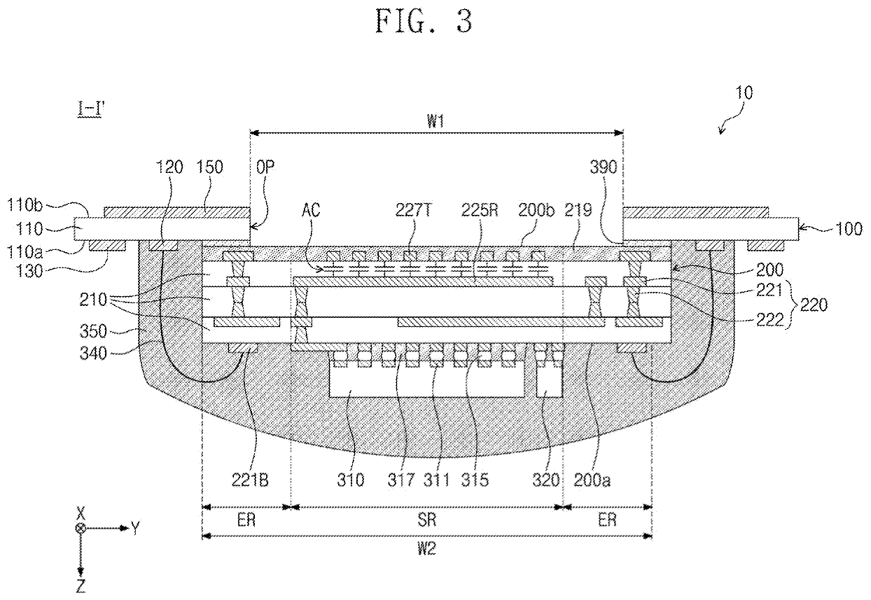

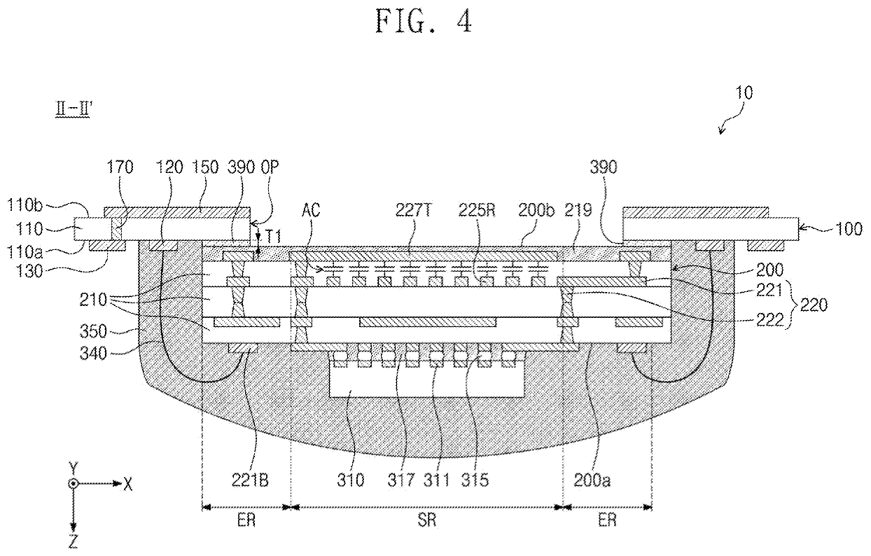

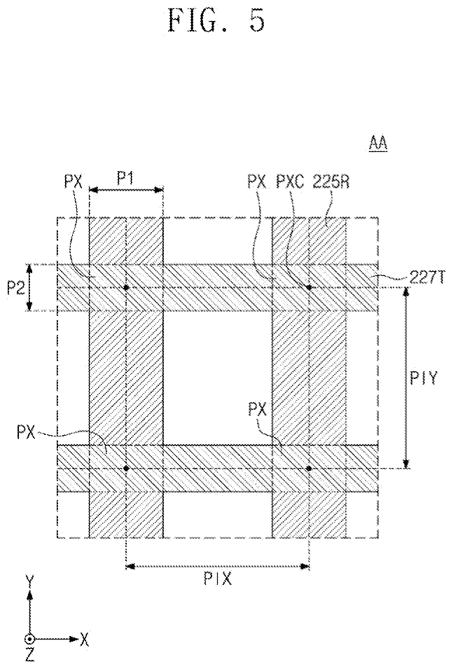

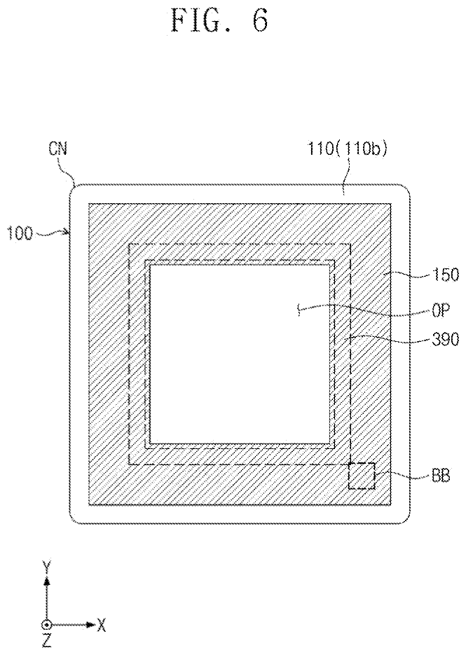

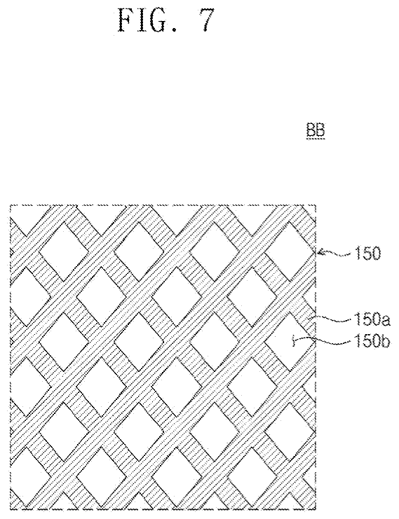

FIG. 2 illustrates a simplified bottom view showing a layout of some components of a fingerprint sensor package according to some embodiments. FIG. 3 illustrates a cross-sectional view taken along line I-I′ of FIG. 2. FIG. 4 illustrates a cross-sectional view taken along line II-IF of FIG. 2. FIG. 5 illustrates an enlarged view showing section AA of FIG. 2. FIG. 6 illustrates a simplified plan view showing a fingerprint sensor package according to some embodiments. FIG. 7 illustrates an enlarged view showing section BB of FIG. 6.

Referring to FIGS. 2, 3, and 4, the fingerprint sensor package 10 may include a package substrate 100, a sensing substrate 200, a controller chip 310, a passive element 320, and a molding layer 350.

The package substrate 100 may include a core dielectric layer 110, first bonding pads 120, external connection pads 130, and a ground bezel 150. The package substrate 100 may be a flexible printed circuit board (FPCB).

The core dielectric layer 110 may have a film or plate shape, and may include a first surface 110a and a second surface 110b which are opposite each other and which face in opposite directions. In embodiments, a first direction X may refer to a direction parallel to the first surface 110a of the core dielectric layer 110, and a second direction Y may refer to a direction that is parallel to the first surface 110a and intersects the first direction X. A third direction Z may be refer to a direction perpendicular to the first surface 110a.

The core dielectric layer 110 may include a dielectric material. For example, the core dielectric layer 110 may be a flexible film including polyimide. For example, the core dielectric layer 110 may include an epoxy resin, an acrylic resin, a polyether nitrile resin, a polyether sulfone resin, a polyethylene terephthalate resin, a polyethylene naphthalate resin, or any suitable synthetic resin.

At least one of the package substrate 100 and the core dielectric layer 110 may include a cavity OP that penetrates therethrough.

The package substrate 100 may include a mounting region on which the sensing substrate 200 may be mounted around the cavity OP. The core dielectric layer 110 may be provided on the first surface 110a with the first bonding pads 120 disposed around the mounting region. For example, the first bonding pads 120 may be arranged along edges of the mounting region of the core dielectric layer 110. The first bonding pads 120 may be connected to conductive wires 340, and may be electrically connected through the conductive wires 340 to second bonding pads 221B of the sensing substrate 200.

The external connection pads 130 may be disposed on the first surface 110a of the core dielectric layer 110. The external connection pads 130 may be disposed adjacent to an edge of the first surface 110a of the core dielectric layer 110, and may be arranged along the edge of the first surface 110a of the core dielectric layer 110. The external connection pad 130 may be closer than the first bonding pad 120 to the edge of the first surface 110a of the core dielectric layer 110. The external connection pad 130 may be a pad which may be electrically and physically connected to an external device (e.g., a card main body 500 discussed below with respect to FIG. 10E). The external connection pad 130 may be electrically connected to the first bonding pad 120 through a conductive pattern provided in the package substrate 100.

The first bonding pads 120 and the external connection pads 130 may include, for example, at least one from among copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), and any alloy thereof.

As shown in FIG. 6, the ground bezel 150 may be disposed on the second surface 110b of the core dielectric layer 110, and around the cavity OP.

Referring to FIGS. 3, 4, and 6, based on the cavity OP being positioned approximately at a central portion of the core dielectric layer 110, the ground bezel 150 may be disposed on an outer portion of the second surface 110b of the core dielectric layer 110. The ground bezel 150 may be disposed around the cavity OP to reduce sensing noise while a fingerprint of a user is in contact with a sensing region SR of the sensing substrate 200. For example, the ground bezel 150 may include a conductive material, for example, metal such as copper (Cu) or aluminum (Al).

According to some embodiments, the ground bezel 150 may be, or may include, a bulk metal layer. According to some embodiments, as shown in FIG. 7, the ground bezel 150 may be shaped as a grid-patterned metal frame 150a, and a pore 150b may be present between neighboring grid lines. A planar area of the ground bezel 150 may be greater than a planar area of the first bonding pad 120.

The ground bezel 150 may be electrically grounded. In some embodiments, as shown in FIG. 4, the ground bezel 150 may be configured to receive a reference potential through a conductive via 170 that penetrates the core dielectric layer 110. The conductive via 170 may be configured to electrically connect the ground bezel 150 to the external connection pad 130, and may be used as an electrical path through which a reference potential is transferred to the ground bezel 150.

In some embodiments, as shown in FIGS. 2 and 4, at least one corner CN of the package substrate 100 may have a rounded shape. In some embodiments, the corner CN of the package substrate 100 may have a curvature radius of about 0.1 mm to about 2 mm. Because the corner CN of the package substrate 100 may have a rounded shape, it may be possible to effectively prevent cracks that could potentially be created in the corner CN during a process in which a punching machine (for example punching machine PM discussed below with respect to FIG. 10D) is used to cut a first panel substrate (for example first panel substrate 100P discussed below with respect to FIG. 10D).

Referring again to FIGS. 2 through 4, the sensing substrate 200 may be disposed on the package substrate 100. The sensing substrate 200 may be mounted on the mounting region on the first surface 110a of the core dielectric layer 110.

An adhesion layer 390 may be interposed between the sensing substrate 200 and the first surface 110a of the core dielectric layer 110. The adhesion layer 390 may bond the sensing substrate 200 to the core dielectric layer 110. The adhesion layer 390 may include a dielectric adhesive. The adhesion layer 390 may include, for example, an epoxy-based adhesive. The adhesion layer 390 may have a thickness T1 of about 10 micrometers (μm) to about 80 μm.

Based on the fingerprint sensor package 10 being engaged to the smart card 1, because the adhesion layer 390 may have the thickness T1 of about 10 μm to about 80 μm, it may be possible to prevent stress from being directly applied to the sensing substrate 200 even when the smart card 1 bends. For example, cracks may be prevented from being created in the sensing substrate 200, which may be less flexible than the package substrate 100.

The sensing substrate 200 may include a printed circuit board (PCB). The sensing substrate 200 may have a third surface 200a and a fourth surface 200b which are opposite to each other, and which face in opposite directions. The third surface 200a of the sensing substrate 200 may be a surface on which a component such as the controller chip 310 may be mounted, and the fourth surface 200b may be in contact with the package substrate 100.

In some embodiments, the sensing substrate 200 may include a rigid-type substrate. The sensing substrate 200 may have a substantially rectangular or square planar shape.

The sensing substrate 200 may be electrically connected through the conductive wires 340 to the package substrate 100. The sensing substrate 200 may include a plurality of dielectric layers 210 and a plurality of conductive structures 220. For example, the sensing substrate 200 may be a multi-layered printed circuit board (PCB). The dielectric layers 210 may include the same or different materials. The dielectric layers 210 may include a dielectric material used for a rigid-type printed circuit board (PCB).

The sensing substrate 200 may have an elastic modulus greater than that of the package substrate 100.

The plurality of conductive structures 220 may include conductive layers 221 and conductive vias 222 through which the conductive layers 221 may be electrically connected to each other. The conductive layers 221 and the conductive vias 222 may include at least one from among copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), carbon (C), and any alloy thereof.

The sensing substrate 200 may include a sensing region SR and a peripheral region ER that surrounds the sensing region SR. For example, the sensing region SR may be an area on which first sensing patterns 225R and second sensing patterns 227T are disposed to allow fingerprint recognition.

The peripheral region ER may be an area on which conductive structures 220 allowing connection between the first sensing patterns 225R and the controller chip 310 may be disposed, and conductive structures 220 allowing connection between the second sensing patterns 227T and the controller chip 310 may be disposed. In addition, the peripheral region ER may be an area on which conductive structures 220 which provide a reference potential and shielding sensing noise are disposed.

The sensing region SR may be disposed on a central portion of the sensing substrate 200. In some embodiments, the sensing region SR may have a rectangular or square shape when viewed in a plan view. A plurality of first sensing patterns 225R may be spaced apart from each other in the first direction X, and may each have a linear shape that extends along the second direction Y. A plurality of second sensing patterns 227T may be spaced apart from each other in the second direction Y, and may each have a linear shape that extends along the first direction X.

The second sensing patterns 227T may be spaced apart from the first sensing patterns 225R in the third direction Z across the dielectric layer 210. In embodiments, the first sensing patterns 225R may be positioned at an upper position, with the dielectric layer 210 below the first sensing patterns 225R, and the second sensing patterns 227T below the dielectric layer 210. For example, the dielectric layer 210 may electrically insulate the second sensing patterns 227T from the first sensing patterns 225R. Therefore, the first sensing patterns 225R may correspond to a first electrode of a capacitor, the dielectric layer 210 may correspond to a dielectric layer of the capacitor, and the second sensing patterns 227T may correspond to a second electrode of the capacitor. For example, the sensing substrate 200 may be provided with a fingerprint sensor which includes capacitors.

The sensing substrate 200 may further include a contact layer 219. The contact layer 219 may be disposed on the sensing region SR. The contact layer 219 may be a portion with which a fingerprint of a user may be in contact, and may include a material having a dielectric constant suitable for fingerprint recognition. When viewed in a plan view, the contact layer 219 may entirely cover the sensing region SR of the sensing substrate 200. The contact layer 219 may protect the sensing region SR against external influences such as contamination, impact, and scratches. Therefore, the contact layer 219 may include high-strength glass and/or plastic, however embodiments are not limited thereto. In some embodiments, the contact layer 219 may include a material (e.g., a high-k dielectric material) having a dielectric constant suitable for fingerprint recognition.

As shown in FIG. 5, the first sensing patterns 225R may each have a first width P1 in the first direction X, and the second sensing patterns 227T may each have a second width P2 in the second direction Y. In some embodiments, the first width P1 may be greater than the second width P2. For example, the first width P1 may be in a range of about 2 times to about 4 times the second width P2. For example, the first width P1 may be in a range of about 40 μm to about 70 μm, and the second width P2 may be in a range of about 5 μm to about 25 μm.

The first sensing patterns 225R and the second sensing patterns 227T may have portions that overlap each other in the third direction Z, and the overlapping portions may correspond to pixels PX. A first pitch PIX in the first direction X between centers PXC of the pixels PX may be substantially the same as a second pitch PIY in the second direction Y between centers PXC of the pixels PX, however embodiments are not limited thereto. For example, the first pitch PIX and the second pitch PIY may each be in a range of about 50 μm to about 90 μm.

The pixels PX may have a combined capacitance value of an area capacitance and a fringing capacitance, each of which may be due to or caused by the first sensing patterns 225R and the second sensing patterns 227T.

When a fingerprint of a user contacts the sensing region SR or the contact layer 219 of the sensing substrate 200, capacitance values that corresponds to the pixels PX may be changed by capacitance induced between the second sensing patterns 227T and the fingerprint of the user. The change in capacitance values may depend on a shape of the fingerprint of the user, and thus the controller chip 310 may identify the fingerprint of the user based on the change in capacitance values of the pixels PX.

Referring again to FIGS. 2 through 4, the controller chip 310 and the passive element 320 may be disposed on the third surface 200a of the sensing substrate 200. The controller chip 310 may be flip-chip mounted on the third surface 200a of the sensing substrate 200. Connection bumps 315 may be provided between the controller chip 310 and the sensing substrate 200 which electrically and physically connect the controller chip 310 and the sensing substrate 200 to each other. The connection bumps 315 may be disposed between some patterns of the conductive layer 221 and chip pads 311 of the controller chip 310. According to some embodiments, an underfill pattern 317 may be interposed between the controller chip 310 and the sensing substrate 200.

In some embodiments, the controller chip 310 may be entirely or partially disposed in the sensing region SR. In some embodiments, the controller chip 310 may be entirely disposed outside the sensing region SR. The controller chip 310 may include any configuration used to perform an operation for recognizing a fingerprint of a user based on a change in capacitance value, for example a memory chip and/or a processor chip. In addition, the passive element 320 may include a capacitor. For example, the capacitor may include a multi-layered ceramic capacitor.

The second bonding pads 221B may be connected to the conductive wires 340, and may be electrically connected through the conductive wires 340 to the first bonding pads 120 of the package substrate 100. The second bonding pads 221B may include a power pad to which a power (e.g., power potential) provided from an external device may be applied, a ground pad to which a reference potential may be applied, and an output pad for output of fingerprint recognition results to the outside (e.g., the display unit 12 of the smart card 1 discussed above with respect to FIG. 1). The controller chip 310 may receive a power potential through one of the second bonding pads 221B and the corresponding wiring line, and may receive a reference potential through one of the second bonding pads 221B and the corresponding wiring line. In addition, the controller chip 310 may receive signals recognized in or obtained using the first and second sensing patterns 225R and 227T.

The molding layer 350 may be disposed on the package substrate 100 to cover the sensing substrate 200, the controller chip 310, the passive element 320, and the conductive wire 340. The molding layer 350 may protect the sensing substrate 200, the controller chip 310, the passive element 320, and the conductive wire 340 against external influences such as contamination and impact.

In addition, the molding layer 350 may cover the first bonding pads 120 disposed on the first surface 110a of the core dielectric layer 110, but may not cover the external connection pads 130, which may allow the external connection pads 130 to be exposed to the outside. On the first surface 110a of the core dielectric layer 110, the molding layer 350 may extend along a boundary between an area on which the first bonding pads 120 are disposed and an area on which the external connection pads 130 are disposed. The molding layer 350 may laterally extend from a lateral surface of the sensing substrate 200 to cover the first bonding pad 120, but may be spaced apart from the external connection pads 130. The molding layer 350 may include an epoxy molding compound (EMC). In embodiments, the molding layer 350 may be formed of an epoxy-based material, a thermosetting material, a thermoplastic material, or an ultraviolet (UV) treated material.

Referring again to FIGS. 2 through 4 and 6, the cavity OP of the package substrate 100 may outwardly expose the fourth surface 200b of the sensing substrate 200. The cavity OP may outwardly expose the sensing region SR of the sensing substrate 200. The cavity OP may expose the contact layer 219 of the sensing substrate 200 to the outside.

The cavity OP may vertically overlap the sensing substrate 200. For example, the cavity OP may vertically overlap the sensing region SR of the sensing substrate 200, but may not vertically overlap at least a portion of the peripheral region ER. When viewed in a plan view, at least a portion of the peripheral region ER may surround the cavity OP.

The cavity OP may have a first width W1 in the first direction X or the second direction Y. The sensing substrate 200 may have a second width W2 in the first direction X or the second direction Y. The first width W1 may be less than the second width W2. The first width W1 may range from about 1 mm to about 50 mm. Because the first width W1 is less than the second width W2, the sensing substrate 200 may be prevented from outwardly escaping through the cavity OP even when an adhesive force of the adhesion layer 390 is reduced in the course of use of the fingerprint sensor package 10.

As shown in FIGS. 2 and 4, when viewed in a plan view, the adhesion layer 390 and the ground bezel 150 may surround the cavity OP. For example, the adhesion layer 390 and the ground bezel 150 may have an annular shape to surround the cavity OP. The annular shape may have a tetragonal shape as shown, however embodiments are not limited thereto. For example, the annular shape may have a circular shape, a polygonal shape, or any other suitable shape in accordance with a planar shape of the cavity OP. When an external stress is applied, the package substrate 100 may bend without suffering from an occurrence of cracking, as compared to the sensing substrate 200. According to embodiments, the adhesion layer 390 may allow the sensing substrate 200 to have a reduced area for fixing to the package substrate 100, and thus the sensing substrate 200 may be protected from cracking. In addition, the adhesion layer 390 may have a thickness of about 10 μm to about 80 μm, and thus it may be possible to prevent stress from being directly applied to the sensing substrate 200.

In the fingerprint sensor package 10 according to the embodiments, because the sensing substrate 200 may include the sensing region SR that may correspond to a fingerprint recognition sensor, the fingerprint sensor package 10 may have a reduced total thickness and may be used to fabricate a smart card whose thickness is equivalent to a thickness of a credit card or check card which is not a smart card. The sensing region SR may be exposed by the cavity OP. A user may bring a fingerprint of the user into direct contact with the sensing region SR, and the fingerprint sensor package 10 may effectively recognize the fingerprint. Accordingly, fingerprint sensitivity may increase, and reliability may improve.

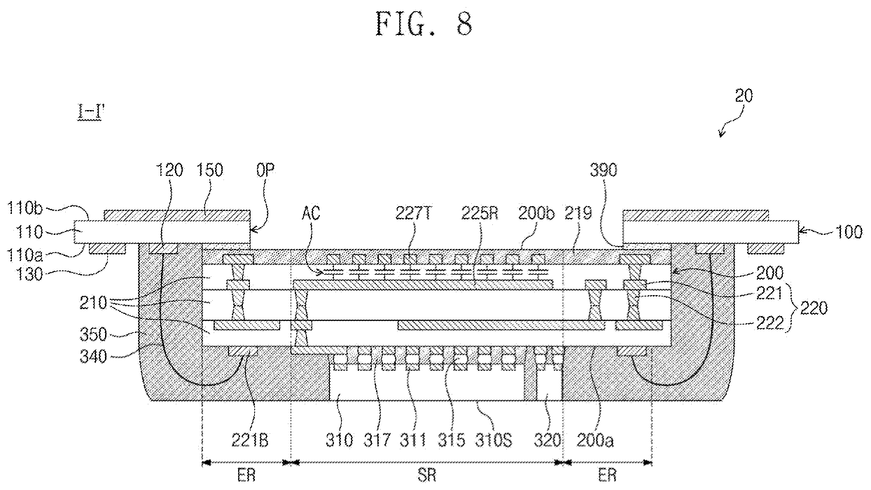

FIG. 8 illustrates a cross-sectional view showing a fingerprint sensor package 20 according to some embodiments. In the following description, redundant or duplicative description of some elements discussed above with reference to FIGS. 2 to 4 may be omitted.

Referring to FIG. 8, a top surface 310S of the controller chip 310 may be exposed through the molding layer 350. Because the top surface 310S of the controller chip 310 may be exposed, thermal radiation effects may increase.

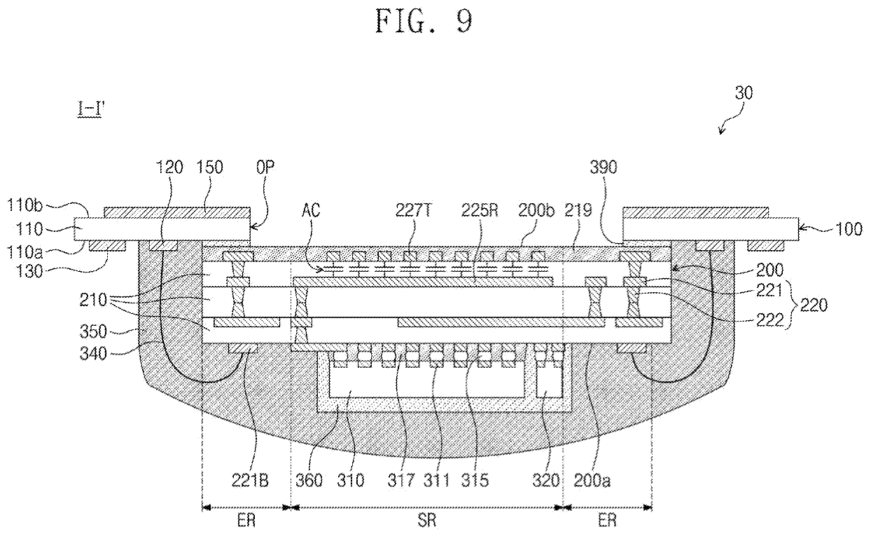

FIG. 9 illustrates a cross-sectional view showing a fingerprint sensor package 30 according to some embodiments. In the following description, redundant or duplicative description of some elements discussed with reference to FIGS. 2 to 4 may be omitted.

Referring to FIG. 9, the fingerprint sensor package 30 may further include an inner molding layer 360 that covers the controller chip 310. The inner molding layer 360 may be interposed between the molding layer 350 and the controller chip 310. An interface may be disposed between the inner molding layer 360 and the molding layer 350.

FIGS. 10A to 10F illustrate cross-sectional views showing a method of fabricating a smart card according to some embodiments.

Referring to FIG. 10A, a sensing substrate 200 may be prepared, and a controller chip 310 and a passive element 320 may be mounted on the sensing substrate 200. The controller chip 310 may be flip-chip mounted on the sensing substrate 200.

Referring to FIG. 10B, a first panel substrate 100P may be prepared on which the sensing substrate 200 is to be mounted. In embodiments, at least some components included in the first panel substrate 100P and materials included in the components may be substantially the same as or similar to those of the package substrate 100 of the fingerprint sensor package 10 discussed above with respect to FIGS. 2 through 7. However, the first panel substrate 100P may have a planar area which may be larger than a planar area of the package substrate 100, which may allow a plurality of sensing substrates 200 to be mounted on the first panel substrate 100P. The first panel substrate 100P may include a plurality of cavities OP. The first panel substrate 100P may be loaded on a winding reel facility, which may control reeling and releasing of the first panel substrate 100P.

After the preparation of the first panel substrate 100P, the sensing substrate 200 may be mounted on a mounting region on a first surface 110a of a core dielectric layer 110. The sensing substrates 200 may be disposed to vertically overlap corresponding cavities OP. The sensing substrate 200 may be fixed through an adhesion layer 390 onto the first panel substrate 100P.

Referring to FIG. 10C, after the sensing substrate 200 is disposed on the first panel substrate 100P, a conductive wire 340 may be formed to electrically connect the first panel substrate 100P and the sensing substrate 200 to each other. The conductive wire 340 may extend between a first bonding pad 120 of the first panel substrate 100P and a second bonding pad 221B of the sensing substrate 200. The conductive wire 340 may be formed by a conductive wire bonding process.

A molding layer 350 may be formed on the first surface 110a of the molding layer 350. The molding layer 350 may cover the sensing substrate 200, the controller chip 310, the passive element 320, and the conductive wire 340. In addition, the molding layer 350 may cover the first bonding pad 120 of the first panel substrate 100P, but may not cover an external connection pad 130. For example, the molding layer 350 may extend as a lateral surface along the first surface 110a of the core dielectric layer 110 from a lateral surface of the sensing substrate 200 to a boundary between the first bonding pad 120 and an external connection terminal.

Referring to FIG. 10D, a punching machine PM may be used to cut the first panel substrate 100P along a sawing line SL. The punching machine PM may cut the first panel substrate 100P to form the fingerprint sensor package 10 discussed above with respect to FIGS. 3 and 4. As the first panel substrate 100P is cut, the first panel substrate 100P may be formed into a plurality of package substrates (for example package substrate 100 of FIGS. 3 and 4). To effectively prevent cracks that may potentially occur when the punching machine PM is used to cut the first panel substrate 100P, the punching machine PM may cut the first panel substrate 100P to cause the package substrate 100 to have a round shaped corner.

Referring to FIG. 10E, a card main body 500 may be prepared, which may include a card board 520, a connection pad 530, and a security chip 11.

The card main body 500 may include a groove region 510 for mounting the fingerprint sensor package 10. The card main body 500 may be provided thereon with the card board 520 and the security chip 11 which may store financial information. For example, a flexible printed circuit board (FPCB) may be used as the card board 520. The security chip 11 may be mounted on the card board 520. The security chip 11 may be disposed in the card main board 500 to outwardly expose one surface of the security chip 11. In addition, the card board 520 may be provided thereon with the connection pad 530 for electrical connection between the fingerprint sensor package 10 and a component in the card main body 500. The connection pad 530 may include a conductive material. The fingerprint sensor package 10 may be aligned with the groove region 510 of the card main body 500 in order to outwardly expose a sensing region SR.

Referring to FIG. 10F, the fingerprint sensor package 10 may be mounted on the card main body 500.

A portion of the fingerprint sensor package 10 may be accommodated in the groove region 510 of the card main body 500. The molding layer 350 of the fingerprint sensor package 10 may be received in the groove region 510, and the external connection pad 130 may be coupled to the connection pad 530 of the card board 520. The external connection pad 130 of the package substrate 100 may be physically and electrically connected to the connection pad 530 of the card board 520. In some embodiments, the molding layer 350 of the fingerprint sensor package 10 may not completely fill the groove region 510, and a flow space may be formed between the fingerprint sensor package 10 an the molding layer 350. The flow space may provide a space in which the fingerprint sensor package 10 copes flexibly with in response to the degree of warpage of a smart card (for example smart card 1 discussed above with respect to FIG. 1). In some embodiments, an adhesive may be coated to fill the flow space.

Referring again to FIG. 1, the smart card 1 may include the fingerprint sensor package 10, the security chip 11, and a display unit 12. When a user brings a fingerprint of the user into contact with the fingerprint sensor package 10 of the smart card 1, based on the recognized fingerprint matching the registered fingerprint, the security chip 11 may grant payment authorization to the user of the smart card 1.

A fingerprint sensor package according to embodiments may include a package substrate including a cavity and a sensing substrate including a sensing region on the package substrate. The sensing region may be exposed by the cavity. A user may bring a fingerprint of the user into direct contact with the sensing region, and the fingerprint sensor package may effectively recognize the fingerprint. Accordingly, fingerprint sensitivity may increase, and reliability may improve.

This detailed description should not be construed as limited to the embodiments set forth herein, and it is intended that the disclosure includes various combinations, modifications and variations without departing from the spirit and scope as defined by the following claims.

What is claimed is:

1. A fingerprint sensor package, comprising:
a package substrate including a cavity;
a sensing substrate on the package substrate, the sensing substrate comprising a first surface and a second surface opposite to each other;
a controller chip on the first surface of the sensing substrate; and
a molding layer on the controller chip and the first surface of the sensing substrate,
wherein the second surface of the sensing substrate is exposed by the cavity.

2. The fingerprint sensor package of claim 1, further comprising a passive element on the first surface of the sensing substrate.

3. The fingerprint sensor package of claim 1, further comprising an adhesive layer between the package substrate and the sensing substrate,
wherein the adhesive layer contacts the second surface of the sensing substrate.

4. The fingerprint sensor package of claim 3, wherein, when viewed in a plan view, the adhesive layer comprises an annulus which surrounds the cavity, and
wherein the adhesive layer has a thickness of about 10 micrometers (μm) to about 80 μm.

5. The fingerprint sensor package of claim 1, wherein the sensing substrate comprises first sensing patterns and second sensing patterns which are closer to the second surface than to the first surface,
wherein the first sensing patterns are spaced apart from each other along a first direction, and extend along a second direction which intersects the first direction,
wherein the second sensing patterns are spaced apart from each other along the second direction and extend along the first direction, and
wherein the first sensing patterns intersect the second sensing patterns when viewed in a plan view.

6. The fingerprint sensor package of claim 1, further comprising:
a first bonding pad on a first surface of the package substrate;
a second bonding pad on the first surface of the sensing substrate; and
a conductive wire which connects the first bonding pad to the second bonding pad,
wherein the molding layer is disposed on the conductive wire, the first bonding pad, and the second bonding pad.

7. The fingerprint sensor package of claim 6, further comprising an external connection pad on the first surface of the package substrate,
wherein the molding layer is not disposed on the external connection pad.

8. The fingerprint sensor package of claim 6, further comprising a ground bezel on a second surface of the package substrate opposite to the first surface of the package substrate,
wherein a planar area of the ground bezel is greater than a planar area of the first bonding pad.

9. The fingerprint sensor package of claim 8, wherein the ground bezel has a grid shape.

10. The fingerprint sensor package of claim 1, wherein the molding layer is disposed on a lateral surface of the controller chip, and
wherein the molding layer is not disposed on a top surface of the controller chip.

11. The fingerprint sensor package of claim 1, further comprising an inner molding layer between the molding layer and the controller chip,
wherein the inner molding layer is disposed on a top surface of the controller chip and lateral surfaces of the controller chip.

12. A fingerprint sensor package, comprising:
a core dielectric layer having a first surface and a second surface opposite to each other, the core dielectric layer comprising a cavity which penetrates from the first surface toward the second surface;
a sensing substrate on the first surface of the core dielectric layer;
a ground bezel on the second surface of the core dielectric layer;
an adhesion layer between the core dielectric layer and the sensing substrate;
a controller chip on the sensing substrate; and
a molding layer on the controller chip, the sensing substrate, and the first surface of the core dielectric layer,
wherein the cavity vertically overlaps the sensing substrate.

13. The fingerprint sensor package of claim 12, wherein the ground bezel comprises an annulus which surrounds the cavity when viewed in a plan view.

14. The fingerprint sensor package of claim 12, wherein the sensing substrate comprises a sensing region,
wherein a plurality of first sensing patterns and a plurality of second sensing patterns are provided on the sensing region,
wherein the plurality of first sensing patterns are spaced apart from each other along a first direction, and extend along a second direction which intersects the first direction, and
wherein the plurality of second sensing patterns are spaced apart from each other along the second direction, and extend along the first direction.

15. The fingerprint sensor package of claim 12, further comprising:
a first bonding pad and an external connection pad on the first surface of the core dielectric layer;
a second bonding pad on the sensing substrate; and
a conductive wire which connects the first bonding pad to the second bonding pad,
wherein the external connection pad is on an edge of the core dielectric layer, and is spaced apart from the sensing substrate across the first bonding pad.

16. The fingerprint sensor package of claim 15, wherein the molding layer is disposed on the first bonding pad, the second bonding pad, and the conductive wire, and
wherein the molding layer is not disposed on the external connection pad.

17. A smart card, comprising:
a main body comprising a groove region and a connection pad;
a security chip in the main body; and
a fingerprint sensor package configured to sense a fingerprint and to transmit a sensing result to the security chip,
wherein the fingerprint sensor package comprises:
a package substrate which comprises a core dielectric layer comprising a cavity, a first bonding pad on a top surface of the core dielectric layer, and an external connection pad on an edge of the top surface;
a sensing substrate on the top surface, wherein the sensing substrate comprises a sensing region on which sensing patterns are provided and a peripheral region on which a second bonding pad is provided, the peripheral region surrounding the sensing region;
a conductive wire extending between the first bonding pad and the second bonding pad, and connecting the first bonding pad to the second bonding pad;
a controller chip on the sensing substrate; and
a molding layer on the sensing substrate and the top surface,
wherein the molding layer is disposed on the sensing substrate and the first bonding pad and exposes the external connection pad,
wherein the external connection pad of the package substrate is coupled to the connection pad of the main body,
wherein the cavity has a first width in a first direction,
wherein the sensing substrate has a second width in the first direction, and
wherein the second width is greater than the first width.

18. The smart card of claim 17, wherein the sensing region of the sensing substrate is exposed by the cavity, and
when viewed in a plan view, at least a portion of the peripheral region of the sensing substrate surrounds the cavity.

19. The smart card of claim 17, wherein the first width of the cavity is in a range of about 1 millimeter (mm) to about 50 mm.

20. The smart card of claim 17, wherein the fingerprint sensor package further comprises an adhesion layer between the core dielectric layer and the sensing substrate,
wherein, when viewed in a plan view, the adhesion layer comprises an annulus which surrounds the cavity, and
wherein the adhesion layer has a thickness of about 10 micrometers (μm) to about 80 μm.
